(19) United States
(12) Patent Application Publication
(10) Pub. No.: US 2012/0076267 A1
(43) Pub. Date: Mar. 29, 2012

(54) RADIOLOGICAL IMAGE RADIOGRAPHING APPARATUS AND METHOD

(75) Inventors: Takao KUWABARA, Kanagawa (JP); Wataru Ito, Kanagawa (JP); Masahiko Yamada, Kanagawa (JP); Yasunori Ohta, Kanagawa (JP); Takeshi Kamiya, Kanagawa (JP); Tetsuro Kusunoki, Kanagawa (JP)

(73) Assignee: FUJIFILM CORPORATION, Tokyo (JP)

(21) Appl. No.: 13/247,379

(22) Filed: Sep. 28, 2011

(30) Foreign Application Priority Data
Sep. 28, 2010 (JP) P2010-216659

(51) Int. Cl. G01N 23/04

(52) U.S. Cl. 378/62

(57) ABSTRACT

Disclosed is a technique for correcting a pixel defect in the capture of two radiological images with parallax therebetween. Radiation beam is directly radiated to a radiation detector 15 in two radiographing directions, without passing through a subject, thereby acquiring two defect detecting radiological images. A pixel defect in each of the two defect detecting radiological images is detected in advance. A pixel position where the pixel defect occurs is stored in advance so as to be associated with each radiographing direction. Then, radiation beam is radiated to the subject from the two radiographing directions to acquire two radiological images for diagnosis. A target pixel which is disposed at the stored pixel position where the pixel defect occurs in each of the two radiological images for diagnosis is corrected.

### BACKGROUND OF THE INVENTION

1. Field of the Invention

The present invention relates to a radiological image radiographing apparatus and method that radiates radiation beam to a subject from two different radiographing directions, detects the radiated radiation with a radiation detector, and acquires two radiological images corresponding to the two radiographing directions. More particularly, the present invention relates to a radiological image radiographing apparatus and method that corrects two acquired radiological images.

2. Description of the Related Art

A radiological image radiographing apparatus has been proposed which radiates radiation beam to a subject in a predetermined radiographing direction, detects the radiated radiation with a radiation detector having a detection plane perpendicular to the radiographing direction, acquires a radiological image of the subject based on a detection signal from the radiation detector, and two-dimensionally displays the radiological image.

When a failure detecting element is existed in the radiation detector, it is known that a pixel defect occurs in the acquired radiological image. The pixel defect may also occur due to the existence of scratches or dust on the detection plane of the radiation detector.

JP2000-126162A discloses a technique that detects a pixel defect occurring due to a failure detecting element, stores the position of the pixel defect, and corrects a position on the radiological image of the subject corresponding to the pixel defect.

### SUMMARY OF THE INVENTION

In recent years, a radiological image radiographing apparatus has been drawn attention which radiates radiation beam to a subject from two different radiographing directions, detects the radiated radiation with a radiation detector, acquires two radiological images with parallax therebetween based on a detection signal from the radiation detector, and captures a radiological image that can be three-dimensionally displayed.

However, when the radiological image that can be three-dimensionally displayed is acquired, the angle formed between each radiographing direction and a direction perpendicular to the detection plane of the radiation detector is arbitrarily set. Therefore, the pixel defect which occurs due to scratches or dust on the surface of the radiation detector varies depending on the radiographing direction in two radiological images that can be three-dimensionally displayed.

Therefore, it is difficult to properly correct the pixel defects in two radiological images that can be three-dimensionally displayed, based on the positional information of the pixel defect detected in a predetermined radiographing direction, and thus acquire a high-quality radiological image.

The present invention has been made in view of the above-mentioned problems and an object of the invention is to provide a radiological image radiographing apparatus and method capable of properly correcting pixel defects in two radiological images that can be three-dimensionally displayed and acquiring a high-quality radiological image.

In order to achieve the object, according to an aspect of the present invention, there is provided a radiological image radiographing apparatus including: a radiation source that radiates radiation beam to a subject from two different radiographing directions; a radiation detector that detects the radiated radiation; an image acquiring unit that acquires two radiological images corresponding to the two radiographing directions based on a detection signal from the radiation detector; a defect detecting unit that detects in advance pixel defects in two defect detecting radiological images which are acquired with the image acquiring unit by directly radiating radiation from the radiation source to the radiation detector in the two radiographing directions without passing through the subject; a defect storage unit that stores in advance a pixel position where the pixel defect occurs in each of the defect detecting radiological images so as to be associated with each radiographing direction; and a defect correcting unit that corrects target pixels disposed at the stored pixel positions in two radiological images for diagnosis which are acquired with the image acquiring unit by radiating radiation beam from the radiation source to the subject from the two radiographing directions. The direct irradiation of radiation to the radiation detector means that the radiation source radiates radiation without placing a subject and the radiation reaches the radiation detector without passing through the subject.

In the radiological image radiographing apparatus according to the above-mentioned aspect of the present invention, the defect detecting unit may acquire pixel values of all pixels in each of the two defect detecting radiological images and detect that the pixel defect occurs in the pixel when the pixel value of the pixel is between two predetermined threshold values.

In the radiological image radiographing apparatus according to the above-mentioned aspect of the present invention, the defect correcting unit may correct the target pixel based on pixel values of adjoining pixels adjoining to the target pixel.

According to another aspect of the present invention, there is provided a radiological image radiographing method including: radiating radiation beam to a subject from two different radiographing directions; detecting the radiated radiation with a radiation detector; acquiring two radiological images corresponding to the two radiographing directions based on a detection signal from the radiation detector; directly radiating the radiation beam to the radiation detector from the two radiographing directions without passing through the subject, thereby acquiring two defect detecting radiological images, and detecting a pixel defect in each of the two defect detecting radiological images in advance; storing in advance a pixel position where the pixel defect occurs in each of the defect detecting radiological images so as to be associated with each radiographing direction; and radiating the radiation beam to the subject from the two radiographing directions to acquire two radiological images for diagnosis and correcting target pixels disposed at the stored pixel positions where the pixel defect occurs in the two radiological images for diagnosis.

According to the radiological image radiographing apparatus and method of the present invention, radiation is directly radiated to the radiation detector in two radiographing directions without passing through a subject, thereby acquiring two defect detecting radiological images. Pixel defects in the two defect detecting radiological images are detected in advance. A pixel position where a pixel defect occurs in each defect detecting radiological image is stored in advance so as to be associated with each radiographing direction. The radiation is radiated to the subject from the two radiographing directions to acquire two radiological images for diagnosis. Target pixels disposed at the stored pixel positions where the pixel defect occurs in the two radiological images for diagnosis are corrected. In this way, even when the pixel position where the pixel defect occurs varies depending on the radiographing direction, it is possible to properly correct the pixel position according to the radiographing direction of the captured radiological image and thus acquire a high-quality radiological image.

### BRIEF DESCRIPTION OF THE DRAWINGS

FIG. 1 is a diagram schematically illustrating the structure of a radiological image radiographing apparatus.

FIG. 2 is a front view illustrating a portion of the radiological image radiographing apparatus.

FIG. 3 is a diagram illustrating the internal structure of a computer.

FIG. 4 is a diagram illustrating a change in a pixel defect depending on a radiographing direction.

FIG. 5 is a diagram illustrating the detection of the pixel defect.

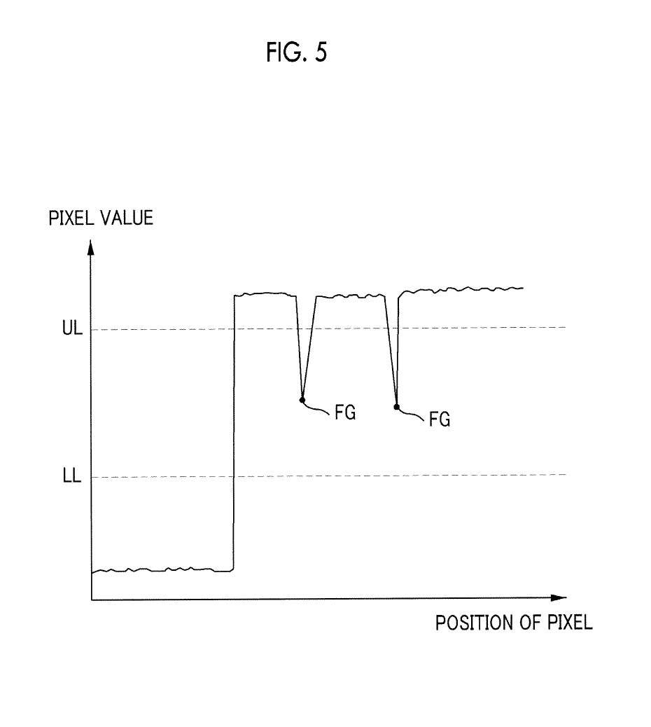

FIG. 6 is a diagram illustrating the correction of the pixel defect.

FIG. 7 is a flowchart illustrating the operation of the radiological image radiographing apparatus.

### DESCRIPTION OF THE PREFERRED EMBODIMENTS

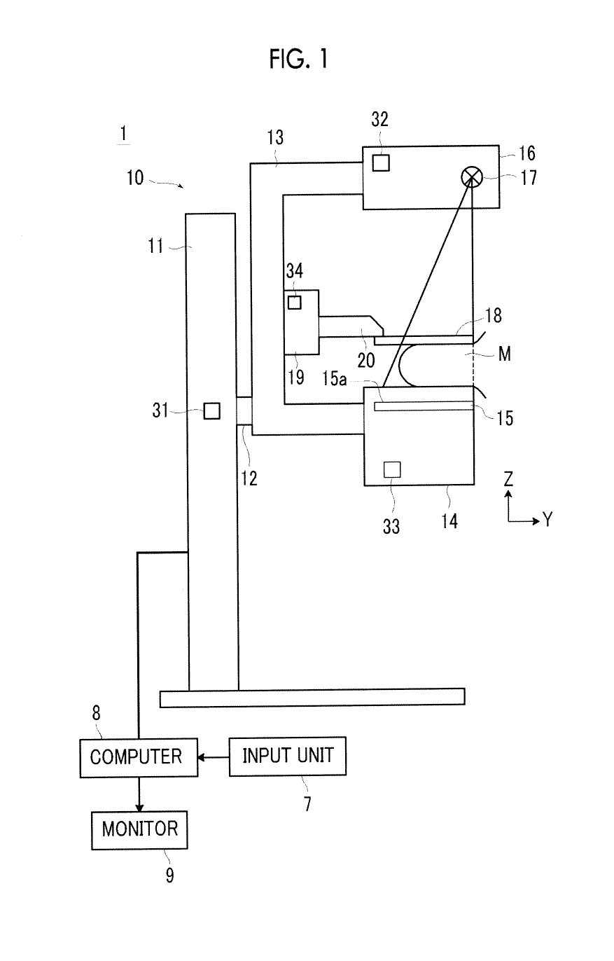

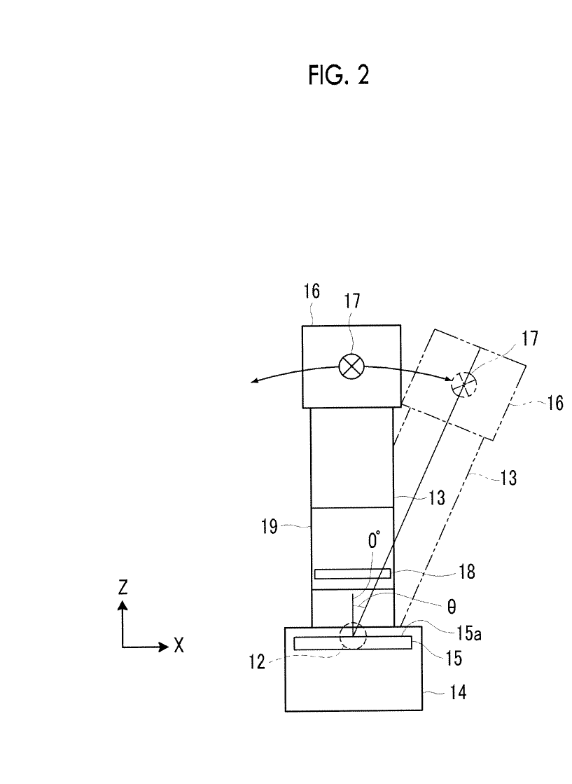

Hereinafter, exemplary embodiments of the present invention will be described with reference to the accompanying drawings. FIG. 1 is a diagram schematically illustrating the structure of a radiological image radiographing apparatus 1 according to an embodiment of the present invention. FIG. 2 is a front view illustrating the radiological image radiographing apparatus 1.

As shown in FIG. 1, the radiological image radiographing apparatus 1 includes a breast imaging apparatus 10, a computer 8 that is connected to the breast imaging apparatus 10, and a monitor 9 and an input unit 7 that are connected to the computer 8.

As shown in FIG. 1, the breast imaging apparatus 10 includes a base 11, a rotating shaft 12 that is movable in the vertical direction (Z direction) relative to the base 11 and is rotatable, and an arm unit 13 that is connected to the base 11 by the rotating shaft 12.

The arm unit 13 has a C-shape and includes one end to which a radiography platform 14 is attached and the other end to which a radiation radiating unit 16 is attached so as to face the radiography platform 14. The rotation and vertical movement of the arm unit 13 are controlled by an arm controller 31 that is incorporated into the base 11.

The radiography platform 14 includes a radiation detector 15, such as a flat panel detector, and a detector controller 33 that controls the reading of a charge signal from the radiation detector 15. In addition, the radiography platform 14 includes, for example, a circuit board provided with a charge amplifier that converts the charge signal read from the radiation detector 15 into a voltage signal, a correlated double sampling circuit that samples the voltage signal output from the charge amplifier, and an A/D converter that converts the voltage signal into a digital signal.

The radiography platform 14 is configured so as to be rotatable with respect to the arm unit 13. Therefore, even when the arm unit 13 is rotated with respect to the base 11, the direction of the radiography platform 14 can be fixed with respect to the base 11.

The radiation detector 15 detects radiation radiated to a detection plane 15a and may be a so-called direct-conversion radiological image detector that directly receives radiation and generates charge or a so-called indirect-conversion radiological image detector that converts radiation into visible light and then converts the visible light into a charge signal.

As a method of reading a radiological image signal, it is preferable to use a so-called TFT reading method of turning on or off a TFT (thin film transistor) switch to read the radiological image signal or a so-called optical reading method of radiating reading light to read the radiological image signal. However, the reading method is not limited thereto, and other methods may be used.

The radiation radiating unit 16 includes a radiation source 17 and a radiation source controller 32. The radiation source controller 32 controls the time when radiation is radiated from the radiation source 17 and the radiation generation conditions (for example, a tube current (mA), radiation time (ms), a tube current-time product (mAs), and a tube voltage (kV)) of the radiation source 17.

In addition, a compression plate 18 that is provided above the radiography platform 14 and compresses a breast M, a supporting portion 20 that supports the compression plate 18, and a moving mechanism 19 that moves the supporting portion 20 in the vertical direction (Z direction) are provided at the center of the arm unit 13. The position and compression pressure of the compression plate 18 are controlled by a compression plate controller 34.

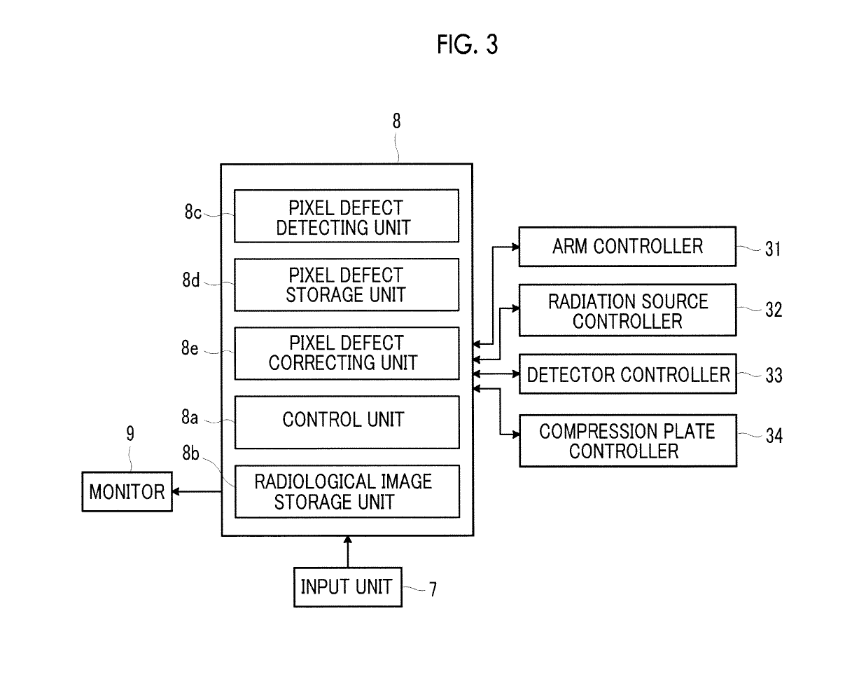

The computer 8 includes, for example, a central processing unit (CPU) and a storage device, such as a semiconductor memory, a hard disk, or an SSD. A control unit 8a, a radiological image storage unit 8b, a pixel defect detecting unit 8c, a pixel defect storage unit 8d, and a pixel defect correcting unit 8e shown in FIG. 3 are formed by these hardware components.

The control unit 8a outputs predetermined control signals to various kinds of controllers 31 to 34 to control the entire system. The radiological image storage unit 8b stores radiological image signals in each radiographing direction acquired by the radiation detector 15. The pixel defect detecting unit 8c detects a pixel defect in a defect detecting radiological image which is acquired by a preliminary imaging process. The pixel defect storage unit 8d stores the pixel position of the detected pixel defect so as to be associated with the radiographing direction. The pixel defect correcting unit 8e corrects a pixel at the stored pixel position, that is, a pixel at the pixel position of the pixel defect stored in the pixel defect storage unit 8d in a radiological image for diagnosis which is acquired by a main imaging process. The detection, storage, and correction of the pixel defect will be described in detail below.

The input unit 7 is, for example, a keyboard or a pointing device, such as a mouse, and receives imaging conditions or an operation instruction input from the radiographer.

The monitor 9 is configured such that it can display the radiological images in each radiographing direction as two-dimensional images using two radiological image signals output from the computer 8, thereby displaying a three-dimensional image.

As a structure that displays the three-dimensional image, for example, the following structure may be used in which two radiological images are respectively displayed on two screens based on two radiological image signals and, for example, a half mirror and/or a polarization glass is used such that one of the two radiological images is incident on the right eve of the observer and the other radiological image is incident on the left eye of the observer, thereby displaying a three-dimensional image.

Alternatively, for example, the following structure may be used: a structure in which two radiological images are displayed so as to overlap each other with a positional deviation corresponding to a predetermined amount of parallax therebetween and a polarization glass is used to generate a three-dimensional image such that the observer can view the three-dimensional image; or a structure, such as a parallax barrier type or a lenticular type, in which two radiological images are displayed on a 3D display that can stereoscopically display two radiological images, thereby generating a three-dimensional image.

In the radiological image radiographing apparatus 1, when there is an imaging start instruction, the aim unit 13 is inclined at a designated radiographing angle θ as shown in FIG. 2 and then radiographing is performed. The radiographing angle θ is formed between the arm unit 13 and a direction perpendicular to the detection plane 15a of the radiation detector 15. In FIG. 2, the counterclockwise direction is the positive direction. The radiographing angle θ is arbitrarily set by the radiographer.

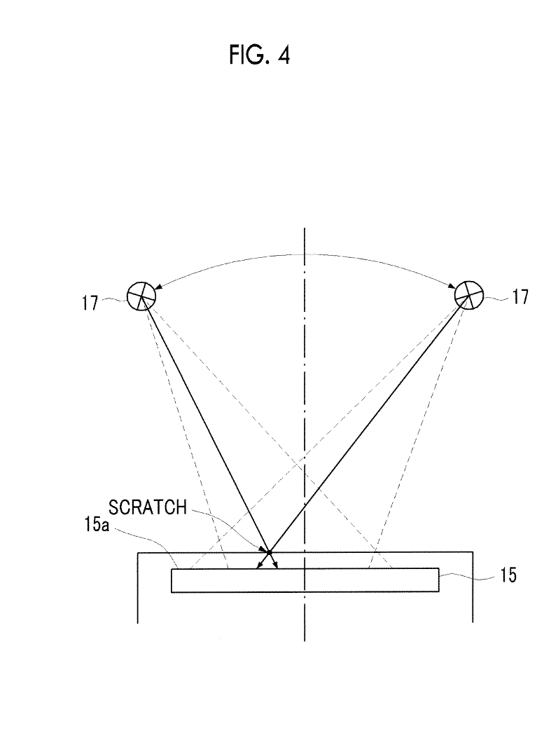

When there is a scratch or dust on the radiography platform 14, a pixel defect occurs in the captured radiological image. As shown in FIG. 4, when the radiographing directions are different from each other, the detected positions of the scratch or dust on the detection plane 15 are different from each other. Therefore, the pixel position where the pixel defect occurs varies depending on the radiographing direction.

Next, the detection and storage of the pixel defect in the radiological image radiographing apparatus 1 will be described. In order to detect a pixel defect, the radiological image radiographing apparatus 1 preliminarily captures the image of the breast M before the main imaging process and acquires a defect detecting radiological image.

The preliminary imaging process is performed without placing the breast M on the radiography platform 14. The radiographing angle θ is set to a value in the main imaging process. Then, the radiation source 17 radiates radiation at the radiographing angle θ. The radiation is directly radiated to the radiation detector 15 without passing through the breast M.

The radiation detector 15 directly detects the radiated radiation, and the detector controller 33 reads a radiological image signal. Then, a defect detecting radiological image is stored in the radiological image storage unit 8b.

The pixel defect detecting unit 8c acquires the pixel value of each pixel in the defect detecting radiological image and detects the pixels with pixel values between an upper limit threshold value UL and a lower limit threshold value LL. Since there is no radiation absorbed by the breast M, the pixels corresponding to a radiation region of the detection plane 15a in the defect detecting radiological image have large pixel values and the pixels corresponding to an un-radiation region have small pixel values.

Therefore, the pixel defect detecting unit 8c detects the pixel with a pixel value that is equal to or more than the upper limit threshold value UL as the pixel in the radiation region, detects the pixel with a pixel value that is equal to or less than the lower limit threshold value LL as the pixel in the un-radiation region, and detects the pixel with a pixel value between the upper limit threshold value UL and the lower limit threshold value LL as a defective pixel FG with a pixel defect.

The pixel defect storage unit 8d stores the position of the defective pixel FG so as to be associated with the radiographing angle θ. The pixel defect storage unit 8d may create a table including the position of each pixel corresponding to each radiographing angle θ and store the table.

Next, a pixel defect correction process of the radiological image radiographing apparatus 1 will be described. After the preliminary imaging process, the radiological image radiographing apparatus 1 performs the main imaging process on the breast M and acquires a radiological image for diagnosis.

In the main imaging process, first, the breast M is placed on the radiography platform 14. As described above, the radiographing angle θ is equal to the value set in the preliminary imaging process. Then, the radiation source 17 radiates radiation at the radiographing angle θ. The radiation is radiated to the radiation detector 15 through the breast M.

The radiation detector 15 detects the radiation passing through the breast M and the detector controller 33 reads a radiological image signal. Then, the radiological image for diagnosis is stored in the radiological image storage unit 8b.

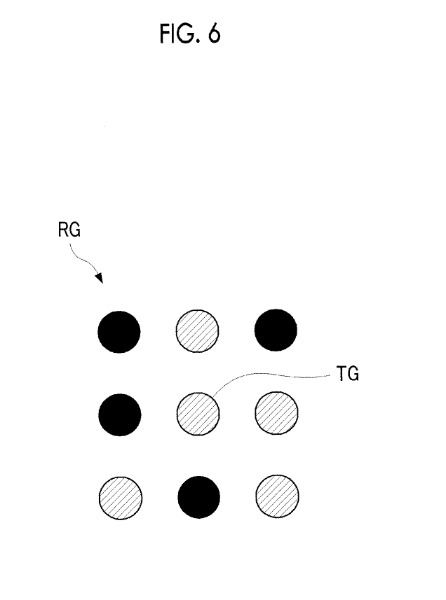

The pixel defect correcting unit 8e corrects a target pixel TG at the stored pixel position in the radiological image for diagnosis. As shown in FIG. 6, the pixel defect correcting unit 8e acquires the pixel values of eight adjoining pixels RG which are adjoin to the target pixel TG, calculates the average pixel value of the adjoining pixels RG, and corrects the pixel value of the target pixel TG to be equal to the average pixel value. The adjoining pixels RG are not limited to the eight pixels adjoin to the target pixel TG, but may be only two pixels which are adjoin to each other in the vertical direction, the horizontal direction, or the oblique direction.

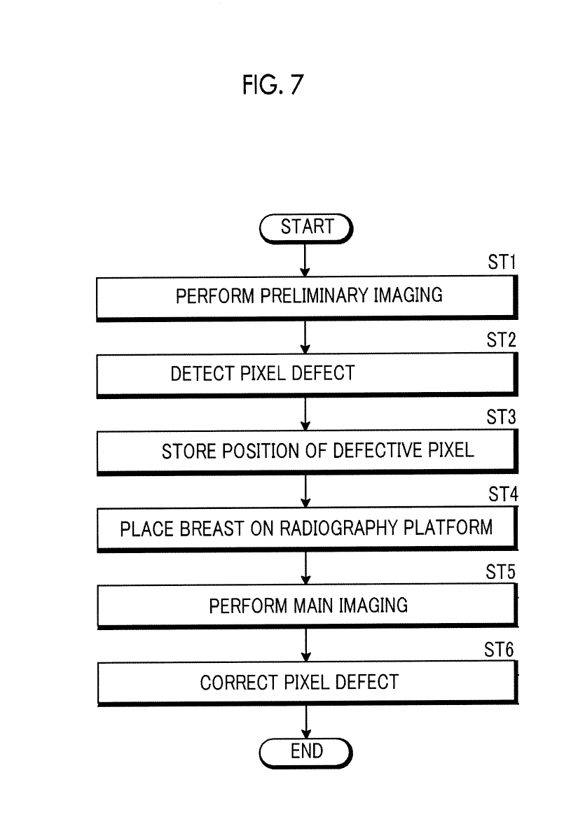

A series of operations of the radiological image radiographing apparatus 1 will be described with reference to FIG. 7. First, various imaging conditions including a combination of the radiographing angles θ forming a convergence angle and a preliminary imaging start instruction to acquire the defect detecting radiological image are input to the input unit 7 without placing the breast M on the radiography platform 14. In this embodiment, it is assumed that imaging is performed by a combination of radiographing angles θ of 0° and 4°.

When the preliminary imaging start instruction is input to the input unit 7, the preliminary imaging process is performed (ST1). First, the control unit 8a reads the radiographing angle θ=0° which is instructed for the preliminary imaging process and outputs the information of the read radiographing angle θ=0° to the arm controller 31.

Then, the arm controller 31 receives the information of the radiographing angle θ=0° output from the control unit 8a and outputs a control signal such that the arm unit 13 is aligned in a direction perpendicular to the detection plane 15a.

Then, the arm unit 13 is aligned perpendicular to the detection plane 15a in response to the control signal output from the arm controller 31. In this state, the control unit 8a outputs control signals to the radiation source controller 32 and the detector controller 33 so as to perform the irradiation of radiation and the reading of a radiological image, respectively.

The radiation source 17 radiates radiation in response to the control signal. The radiation detector 15 detects radiation radiated in the direction in which the radiographing angle θ is 0°, and the detector controller 33 reads a radiological image signal from the radiation detector 15. The radiological image storage unit 8b stores a radiological image for detection. The above-mentioned process is repeatedly performed and a radiological image for detection when the radiographing angle θ is 4° is stored.

The pixel defect detecting unit 8c acquires the pixel values of all pixels in the radiological images for detection when the radiographing angle θ is 0° and 4° and detects the defective pixel FG in each of the radiological images for detection based on the upper limit threshold value UL and the lower limit threshold value LL (ST2). The pixel defect storage unit 8d stores the positions of the defective pixels FG so as to be associated with the radiographing angle θ (ST3). In this way, the preliminary imaging process ends.

Then, the breast M is placed on the radiography platform 14 and the compression plate 18 compresses the breast M with predetermined pressure (ST4). Then, a main imaging start instruction is input to the input unit 7 and the main imaging process is performed (ST5). The main imaging process is performed at radiographing angles θ of 0° and 4° in the same way as that in the preliminary imaging process. The radiological image storage unit 8b stores radiological images for diagnosis at the radiographing angles θ of 0° and 4°.

The pixel defect correcting unit 8e corrects the pixel value of the target pixel TG disposed at the stored pixel position in the radiological image for diagnosis at each radiographing angle so as to be equal to the average pixel value of the adjoining pixels RG around the target pixel TG (ST6). The radiological image for diagnosis whose pixel defect has been corrected is three-dimensionally displayed on the monitor 9. In this way, a series of processes ends.

As described above, according to the radiological image radiographing apparatus and method of the embodiment of the present invention, in the preliminary imaging process, radiation is directly radiated to the radiation detector 15 in two radiographing directions without passing through the breast M and two defect detecting radiological images are acquired. In addition, pixel defects in the two defect detecting radiological images are detected in advance, and the pixel position where the pixel defect occurs in each of the two defect detecting radiological images is stored in advance so as to be associated with each radiographing direction.

In the subsequent main imaging process, radiation is radiated in two radiographing directions and then passes through the breast M, and two radiological images for diagnosis are acquired. In addition, the target pixels TG disposed at the stored pixel positions in the two radiological images for diagnosis are corrected. Therefore, even when the pixel position where the pixel defect occurs varies depending on the radiographing direction, it is possible to correct the pixel defect of the radiological image for diagnosis and thus acquire a high-quality radiological image.

The radiological image radiographing apparatus 1 may perform the preliminary imaging process at all radiographing angles θ and store the positions of the defective pixels FG at all radiographing angles θ in advance. In the above-described embodiment, the radiological image radiographing apparatus according to the present invention is applied to the breast imaging apparatus, but the subject is not limited to the breast. For example, the present invention can be applied to a radiological image radiographing apparatus that captures an image of the chest or the head.

What is claimed is:

1. A radiological image radiographing apparatus comprising:
a radiation source that radiates radiation beam from two different radiographing directions;
a radiation detector that detects the radiated radiation;
an image acquiring unit that acquires two radiological images corresponding to the two radiographing directions based on a detection signal from the radiation detector;
a defect detecting unit that detects pixel defects in two defect detecting radiological images which are acquired with the image acquiring unit by directly radiating radiation beam from the radiation source in the two radiographing directions to the radiation detector;
a defect storage unit that stores a pixel position where the pixel defect occurs in each of the defect detecting radiological images so as to be associated with each radiographing direction; and
a defect correcting unit that corrects target pixels disposed at the stored pixel positions in two radiological images for diagnosis which are acquired with the image acquiring unit by radiating radiation beam from the radiation source in the two radiographing directions to a subject.

2. The radiological image radiographing apparatus according to claim 1,
wherein the defect detecting unit acquires pixel values of all pixels in each of the two defect detecting radiological images and detects that the pixel defect occurs when the pixel value is between two predetermined threshold values.

3. The radiological image radiographing apparatus according to claim 1,
wherein the defect correcting unit corrects the target pixel based on pixel values of adjoining pixels adjoining to the target pixel.

4. The radiological image radiographing apparatus according to claim 2,
wherein the defect correcting unit corrects the target pixel based on pixel values of adjoining pixels adjoining to the target pixel.

5. A radiological image radiographing method comprising:
radiating radiation beam from two different radiographing directions;
detecting the radiated radiation beam with a radiation detector;
acquiring two radiological images corresponding to the two radiographing directions based on a detection signal from the radiation detector;
directly radiating the radiation beam to the radiation detector from the two radiographing directions to acquire two defect detecting radiological images and detecting a pixel defect in each of the two defect detecting radiological images;
storing a pixel position where the pixel defect occurs in each of the defect detecting radiological images so as to be associated with each radiographing direction; and
radiating the radiation beam to a subject from the two radiographing directions to acquire two radiological images for diagnosis and correcting target pixels disposed at the stored pixel positions in the two radiological images for diagnosis.
